(19) United States
(12) Patent Application Publication
(10) Pub. No.: US 2014/0142955 A1
(43) Pub. Date: May 22, 2014

(54) Encoding Digital Media for Fast Start on Digital Media Players

(71) Applicant: APPLE INC., Cupertino, CA (US)

(72) Inventors: Thomas Matthieu Alsina, Mountain View, CA (US); Steve S. Gedikian, Redwood City, CA (US)

(73) Assignee: APPLE INC., Cupertino, CA (US)

(21) Appl. No.: 13/681,350

(22) Filed: Nov. 19, 2012

(51) Int. Cl. G10L 19/008

(52) U.S. Cl. CPC G10L 19/008
USPC 704/500

(57) ABSTRACT

Systems, methods and computer program products are disclosed for encoding digital media for fast start on digital media players. In some implementations, a set of frames at the beginning of a digital media file or stream are encoded at a first bitrate (e.g., a constant low bitrate), and subsequent frames of the digital file or stream are encoded at a second, bitrate that may be higher than the first bitrate.

### TECHNICAL FIELD

This disclosure is related generally to digital media encoding and decoding.

### BACKGROUND

Advances in computer networking, combined with powerful computing devices have made streaming digital media practical and affordable for consumers. A number of online media services have emerged to enable users to listen digital media streams, such as video, audio and live broadcasts (e.g., Internet radio services). The digital media streams may be compressed for storage and streaming. A digital media stream may be streamed live or on demand. Live streams are generally provided at one time only by sending the live stream directly to a media player without saving the file to storage. On-demand streaming is often provided by progressive streaming or progressive download that saves the digital media file to storage on the media player device for playback to the user.

A common problem encountered with digital media streaming applications is that it may take a long time for a media stream to download and start playing on a digital media player due to the amount of data that must be transported, buffered and decoded. Digital media that has been encoded with higher number of bits per sample will have a better resolution than digital media encoded with a lessor number of bits per sample. A higher number of bits per sample, however, results in a larger file size, which takes longer to download or stream to a media player, resulting in a longer delay before playback begins.

### SUMMARY

Systems, methods and computer program products are disclosed for encoding of digital media for fast start on digital media players. In some implementations, a set of frames at the beginning of a digital media file or stream is encoded at a first bitrate (e.g., a constant low bitrate), and subsequent frames of the digital media file or stream are encoded at a second, bitrate that may be higher than the first bitrate.

In some implementations, a fast start time of an audio file or stream (e.g., songs) by a digital media player is obtained by encoding the beginning of the audio file or stream with a lower bitrate or lower average bitrate (e.g., 128 kbits/s for MP3 or AAC). Because a few seconds (e.g., 5 seconds) are often needed for the ears of the average listener to adjust to the sound, the average listener may not notice the poorer sound quality due to the lower bitrate encoding. The first N frames encoded with the lower average bitrate can be downloaded quickly from a digital media streaming service to enable the fast start time. While the first N frames are being played back by the media player, the rest of the frames can be downloaded at a slower rate and played back at higher bitrates or higher average bitrates (e.g., 160-320 kbits/s for AAC or MP3).

Other implementations are directed to systems, computer program products and computer-readable mediums.

Particular implementations disclosed herein provide one or more of the following advantages. Digital media files and streams can be played back faster by encoding the beginning frames of the file or stream at a lower bitrate. The lower bitrate creates a perception of instant playback for the listener and thus an improved experience with the digital media streaming service.

The details of the disclosed implementations are set forth in the accompanying drawings and the description below. Other features, objects, and advantages will be apparent from the description and drawings, and from the claims.

### DESCRIPTION OF DRAWINGS

FIG. 1 is a block diagram of an exemplary system for streaming digital media encoded using the process described in FIG. 2.

FIG. 2 is a flow diagram of an exemplary encoding process.

FIG. 3 is a flow diagram of an exemplary decoding process.

FIG. 4 is a block diagram of exemplary device architecture for encoding/decoding digital media files or streams.

The same reference symbol used in various drawings indicates like elements.

### DETAILED DESCRIPTION

### Exemplary System for Streaming Digital Media

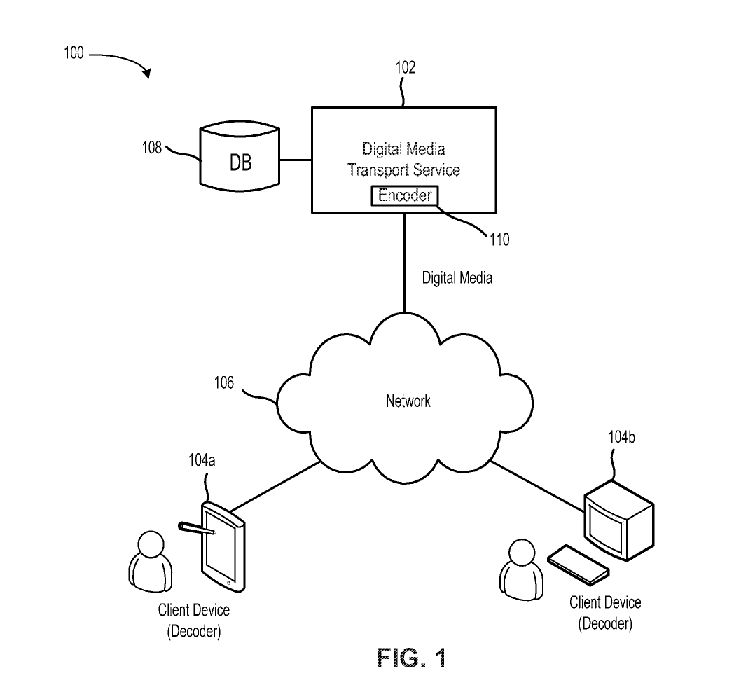

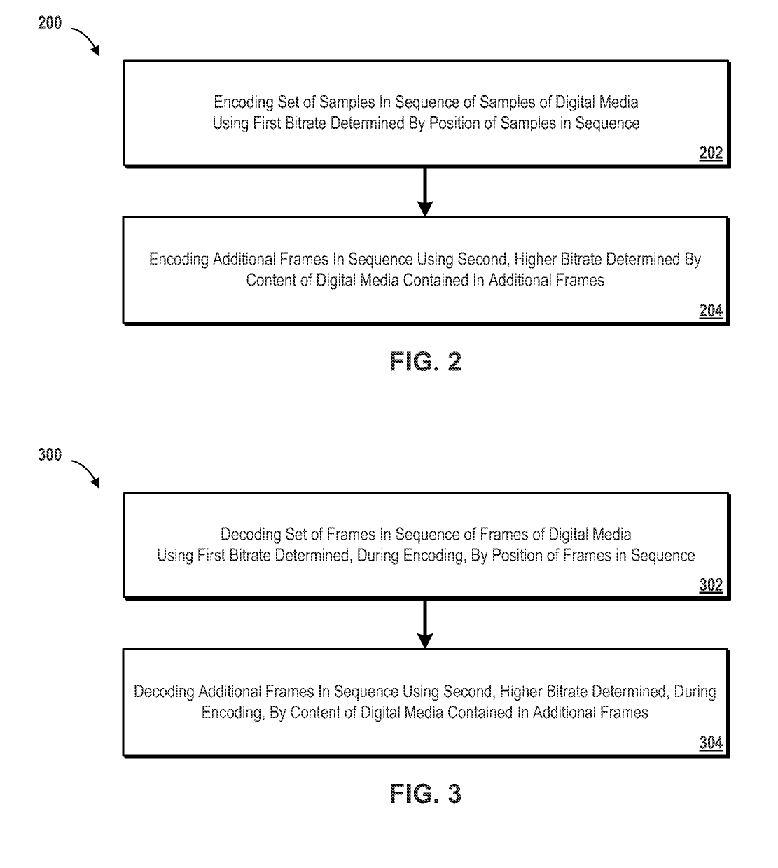

FIG. 1 is a block diagram of an exemplary system 100 for streaming digital media encoded using the process described in FIG. 2. In some implementations, system 100 may include digital media transport service 102 coupled to client devices 104 through network 106.

An example digital media transport service 102 is an Internet radio service or other media streaming service for streaming music to client devices 104. Digital media transport service 102 may include one or more server computers and other equipment for transporting encoded digital media to client devices 104. Digital media may be any digital information, including but not limited to, audio, video and multimedia. The digital media can be stored in a database 108 accessible by digital media transport service 102.

Digital media transport service 102 may include encoder 110 for encoding the digital media using hardware and/or software. For example, an audio stream may be compressed using a standard or open source protocol, such as MP3 or Advanced Audio Coding (AAC). A video stream may be compressed using a video codec such as H.264 or VP8. Encoded audio and video streams may be assembled in a container bitstream, such as Flash Video (FLV), WebM, Advance Systems Format (ASF) or Internet Media Streaming Alliance (ISMA). The bitstream may be delivered from media streaming service 102 to client devices 104 using a transport protocol, such as Microsoft Media Server (MMS), Real-time Transfer Protocol (RTP), Audio Data Transport Stream (ADTS) or HTTP Live Streaming. Client devices 104 may interact with digital media transport service 102 using a control protocol, such as MMS or Real-time Streaming Protocol (RTSP).

Client devices 104 may be any device capable of receiving, decoding and playing digital media provided by digital media transport service 102. Client devices 104 can run media player applications that are capable of decoding digital media files and streams provide by media streaming service 102. Some examples of client devices 104 include but are not limited to personal computers, smart phones, electronic tablets, televisions systems, navigation systems, game consoles, etc. Client devices 104 may communicate with digital media transport service 102 through various wired (e.g., Ethernet) or wireless connections (e.g., WiFi, cellular) to network 106.

Network 106 may be a collection of one or more networks that include hardware (e.g., router, hubs) and software capable of transporting digital media from one device to another device. Some examples of network 106 are Local Area Networks (LAN), Wide Area Networks (WAN), Wireless LAN (WLAN), Internet, intranets, cellular networks and the Public Switched Telephone Network (PSTN).

### Exemplary Encoding Process

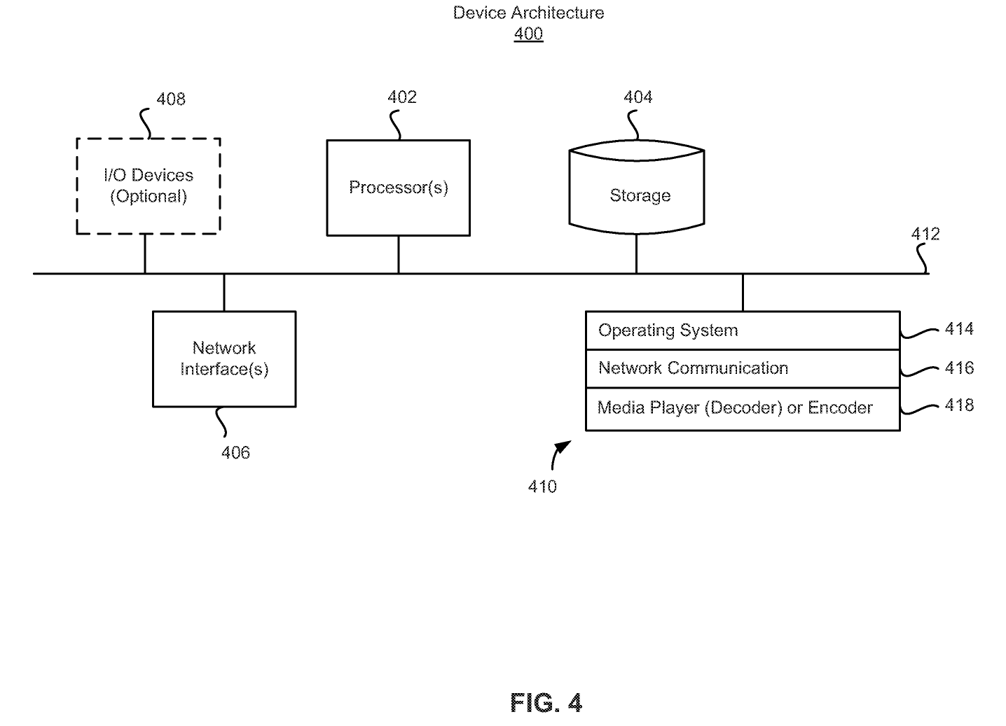

FIG. 2 is a flow diagram of an exemplary encoding process. Process 200 may be implemented by encoder 110 shown in FIG. 1 using the architecture described in reference to FIG. 4. A typical audio file (e.g., an MPEG audio file) includes a number of frames. Each frame has its own header and audio content. Variable Bitrate (VBR) MPEG files use bitrate switching, which means that the bitrate of the audio content can change from frame to frame. VBR can use lower bitrates in frames where it will not reduce sound quality. This allows for better compression while keeping a high sound quality. For MP3, the frame header comprises the first four bytes (32 bits) of a frame. The first eleven bits of the frame header are called “frame sync” bits. MP3 headers may also use 16 Cyclic Redundancy Check (CRC) bits, which follow the frame header. After the CRC bits is the audio content, which for VBR MPEG files can include a variable number of bits of audio content.

To enable fast start of a digital media file or stream by a media player, encoder 110 can encode a set of frames located at the beginning of the digital media file with a lower bitrate. For audio in particular, a listener may not notice the poor quality audio (due to the lower bitrate) in the first few seconds (e.g., 5 seconds) of playback of the digital media. For example, the first few seconds of a digital media file or stream may be silence, periodic or have small or no transients. Encoding the first N frames at the beginning of a digital media file at a lower bitrate allows the frames to download quickly to the digital media player from the media streaming service, creating a perception of instant playback to the listener. Since it takes a typical listener a few seconds for their ears to adjust to the audio, the poor quality audio played back during those seconds may not be perceived by the listener.

While the first N frames are played back, subsequent frames in the digital media file or stream, which are encoded at a higher bitrate can be transported to the digital media player at a slower rate due to the larger file size.

In some implementations, process 200 may begin by encoding a set of frames in a sequence of frames of a digital media file or stream using a first bitrate determined by the position (e.g., the first frame of the sequence) of the set of frames in the sequence (202). For example, the first N frames starting at the beginning of the digital media file or stream can be encoded at the first bitrate. This can be an average constant bitrate (CBR) (e.g., 128 kbits/s for AAC or MP3). The number of frames N can be determined based on analysis of the digital media and can be different for different media. For example, the encoder can analyze the first N frames of a digital audio file to identify the presence of transients that may need to be encoded at a higher average bitrate (e.g., 160-320 kbits/s for AAC or MP3) to achieve a desired sound quality, making a lower constant bitrate encoding unacceptable. If there are transients with significant magnitude or energy (above a noise threshold) at the beginning of the audio file, then the encoder may forego the lower bitrate encoding and may encode the entire file using a higher bitrate or average bitrate and possibly a more complex VBR or CBR encoding scheme.

Process 200 may continue by encoding subsequent frames in the sequence of frames using a second bitrate determined by content of the digital media contained in the subsequent frames (204). For example, the next M frames after the first N frames in the digital media file or stream can be encoded using standard encoders based on a psychoacoustic model (e.g., MP3, AAC).

In some implementations, VBR or CBR encoding can be applied to frames of digital media using multi-pass (e.g., two pass) encoding. VBR encoding can be controlled by a fixed quality setting, bitrate range (minimum and maximum allowed bitrate) or average bitrate setting. In a first pass of a two-pass encoding, the content of the input frames are analyzed to determine an optimal number of bits to encode the frame to achieve a desired quality based on a psychoacoustic model. The bitrates determined in the first pass may be stored in a file. In the second pass, the file may be used to encode the frames according to the bitrates determined in the first pass (e.g., using entropy encoding).

During the first pass, the frequency content analysis of the first N frames starting from the beginning of the digital media file can be skipped and a predefined lower average bitrate (e.g., 128 kbits/s for AAC or MP3) or lower average bitrate encoding process (e.g., Low Complexity AAC) can be applied to the first N frames. The lower average bitrate can be replaced with a constant bitrate that does not change for the N frames. The M subsequent frames (where M and N are integers and M>N) in the digital media file or stream can be processed using standard VBR encoding techniques, where higher average bitrates (e.g., 160-320 kbits/s for AAC or MP3) may be selected based on the content contained in the frames (e.g., the presence of transients) and a psychoacoustic model.

During the second pass, the frames are encoded according to the bitrates determined in the first pass. The encoded digital media file can then be transported as a file download, streaming media or progressive download to media players using standard transport protocols, such as RTSP, ADTS or HTTP Live Streaming protocol. The transport protocols may include one or more of metadata, frame headers or tables that can contain VBR information (e.g., bitrates, sample offsets), which can be used by a decoder in a digital media player to decode the digital media file or stream, as described in reference to FIG. 3.

For M4A (MPEG 4 container) files, digital media files may include a table appended to the beginning of the file that includes offsets to mark the start location of each sample of the digital media file and corresponding times for each sample. These sample offsets and associated times can be used by a seek control or scrubber of the media player to start playback of the digital media at various locations in the digital media file and ensure a correct display of time duration. These sample offsets can also be used by a decoder to compute an average sample bitrate by dividing the difference between two sample offsets, by the difference between the two corresponding times for the samples.

For MP3 or AAC, frames include headers that contain information that can be used by a decoder to determine or derive bitrates (e.g., a bitrate index for MP3). Publicly available specifications describing header formats that may be configured for CBR and VBR encoding are publicly available from standards organizations (e.g., MPEG).

For HTTP Live Streaming, a multimedia presentation (e.g., video and audio) is specified by a Uniform Resource Identifier (URI) to a Playlist file, which is an ordered list of media URIs and information tags. The URIs and their associated tags specify series of media segments accessible by a media server computer. To play the media stream, client devices 104 first obtain the Playlist file from a media server computer and then obtain and play each media segment in the Playlist, which are also accessible through the media server The Playlist file can be reloaded to discover subsequent segments. A URI line in the Playlist identifies a media segment or a variant Playlist file. A variant Playlist file can list each variant stream to allow client devices 104 to switch between segments encoded with different bitrates dynamically, using the syntax and structures described in Section 6.2.4 of the Internet-Draft for “HTTP Live Streaming,” dated Oct. 15, 2012, which is distributed publicly by the Internet Engineering Task Force (IETF).

### Exemplary Decoding Process

FIG. 3 is a flow diagram of an exemplary decoding process 300. Process 300 may be implemented by decoders in client devices 104 shown in FIG. 1 using the architecture described in reference to FIG. 4.

In some implementations, process 300 may begin by decoding (e.g., in a digital media player) a set of frames in a sequence of frames of digital media using a first bitrate determined, during encoding, by a position of the frames in the sequence (302). For example, the first N frames in the sequence can be encoded at a lower average bitrate (e.g., 128 kbits/s for AAC or MP3). Information related to the bitrate can be transported to a decoder in the form of metadata (e.g., in a header or table), which can be contained in or appended to the digital media file or stream, or provided through a different channel to the digital media player (e.g., through a separate bitstream). The metadata can include the bitrates for each frame or sample of the digital media file or stream. The metadata can include information that can be used to derive or calculate the bitrate for each frame or sample of the digital media file or stream.

Process 304 may continue by decoding subsequent frames in the sequence of frames using a second bitrate determined, during encoding, by content of the digital media contained in the subsequent frames (304). For example, M subsequent frames in the sequence (where M>N) can be encoded using a higher average bitrate than the first bitrate (e.g., 160-320 kbits/s for AAC or MP3). An example of content of the digital media can be whether the frames contain content that includes transients, silence or periodic signals. If transients are present above a noise threshold (e.g., a snare drum rim shot) are present in the content, then those transients may be encoded with more bits to ensure a desired sound quality based on a psychoacoustic model (e.g., MP3, AAC VBR encoding). Periods of silence, periodic signals and other non-transient signals may be encoded with fewer bits to obtain a desired sound quality based on the psychoacoustic model.

### Exemplary Architecture

FIG. 4 is a block diagram of exemplary device architecture 400 for implementing the features and processes described in reference to FIGS. 1-3.

The architecture 400 may be implemented on any data processing apparatus that runs software applications derived from instructions, including without limitation personal computers, smart phones, electronic tablets, game consoles, servers or mainframe computers. In some implementations, the architecture 400 may include processor(s) 402, storage device(s) 404, network interfaces 406, Input/Output (I/O) devices 408 and computer-readable medium 410 (e.g., memory). Each of these components may be coupled by one or more communication channels 412.

Communication channels 412 may be any known internal or external bus technology, including but not limited to ISA, EISA, PCI, PCI Express, NuBus, USB, Serial ATA or FireWire.

Storage device(s) 404 may be any medium that participates in providing instructions to processor(s) 402 for execution, including without limitation, non-volatile storage media (e.g., optical disks, magnetic disks, flash drives, etc.) or volatile media (e.g., SDRAM, ROM, etc.).

I/O devices 408 can include displays (e.g., touch sensitive displays), keyboards, control devices (e.g., mouse, buttons, scroll wheel), loud speakers, audio jack for headphones, microphones and another device that can be used to input or output information.

Computer-readable medium 410 may include various instructions 414 for implementing an operating system (e.g., Mac OS®, Windows®, Linux). The operating system may be multi-user, multiprocessing, multitasking, multithreading, real-time and the like. The operating system performs basic tasks, including but not limited to: keeping track of files and directories on storage devices(s) 404; controlling peripheral devices, which may be controlled directly or through an I/O controller; and managing traffic on communication channels 412. Network communications instructions 416 may establish and maintain network connections with client devices (e.g., software for implementing transport protocols, such as TCP/IP, RTSP, MMS, ADTS, HTTP Live Streaming).

Computer-readable medium 410 may store instructions, which, when executed by processor(s) 402 implement an encoder or media player (decoder) 418. For server computers operated by digital media transport service 102 (FIG. 1), applications 418 may include an encoder for encoding digital media files stored in database 108. For client devices (104a, 104b), computer-readable medium 410 may store instructions, which, when executed by processor(s) 402 implement a media player (decoder) for decoding and playing back digital media files or streams to a listener.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). For example, the data access daemon may be accessed by another application (e.g., a notes application) using an API. An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method of encoding digital media comprising:
encoding a set of frames in a sequence of frames of a digital media using a first bitrate, the first bitrate determined based on a position of the set of frames in the sequence of frames; and
encoding subsequent frames in the sequence of frames using a second bitrate that is higher than the first bitrate, the second bitrate determined based on content of the digital media contained in the subsequent frames,
where the method is performed by one or more hardware processors.

2. The method of claim 1, where the set of frames is encoded with a constant bitrate and the subsequent frames are encoded with a constant bitrate or variable bitrate.

3. The method of claim 1, where the first bitrate and the second bitrate are average bitrates.

4. The method of claim 1, where the digital media is audio and the encoding is implemented by one of Advanced Audio coding (AAC), MP3, MP4A or HTTP Live Streaming.

5. The method of claim 1, further comprising:
including or appending information to the encoded digital media that is related to the first bitrate and second bitrate; and
initiating transporting of the information to one or more decoders.

6. The method of claim 1, where the information is included in a table or frame header.

7. A method of decoding digital media comprising:
decoding a set of frames in a sequence of frames of a digital media using a first bitrate, where the first bitrate was determined, during encoding, based on a position of the first set of frames in the sequence of frames; and
decoding subsequent frames in the sequence of frames using a second bitrate that is higher than the first bitrate, the second bitrate determined, during encoding, based on content of the digital media contained in the subsequent frames,
where the method is performed by one or more hardware processors.

8. The method of claim 7, where the set of frames is encoded with a constant bitrate and the subsequent frames are encoded with a constant bitrate or variable bitrate.

9. The method of claim 7, where the first bitrate and the second bitrate are average bitrates.

10. The method of claim 7, where the digital media is audio and the encoding is implemented by one of Advanced Audio coding (AAC), MP3, MP4A and HTTP Live Streaming.

11. The method of claim 7, where the decoding further comprises:
obtaining information related to the first and second bitrates from a table or frame header; and
using the information to determine or derive the first and second bitrates.

12. A system of encoding digital media comprising:
one or more processors;
memory coupled to the one or more processors and configured to store instructions, which, when executed by the one or more processors, causes the one or more processors to perform operations comprising:
encoding a set of frames in a sequence of frames of a digital media using a first bitrate, the first bitrate determined based on a position of the set of frames in the sequence of frames; and
encoding subsequent frames in the sequence of frames using a second bitrate that is higher than the first bitrate, the second bitrate determined based on content of the digital media contained in the subsequent frames.

13. The system of claim 12, where the set of frames is encoded with a constant bitrate and the subsequent frames are encoded with a constant bitrate or variable bitrate.

14. The system of claim 12, where the first bitrate and the second bitrate are average bitrates.

15. The system of claim 12, where the digital media is audio and the encoding is implemented by one of Advanced Audio coding (AAC), MP3, MP4A and HTTP Live Streaming.

16. The system of claim 12, further comprising:
including or appending information to the encoded digital media that is related to the first bitrate and second bitrate; and
initiating transporting of the information to one or more decoders.

17. The system of claim 12, where the information is included in a table or frame header.

18. A system of decoding digital media comprising:
one or more processors;
memory coupled to the one or more processors and configured to store instructions, which, when executed by the one or more processors, causes the one or more processors to perform operations comprising:
decoding a set of frames in a sequence of frames of a digital media using a first bitrate, where the first bitrate was determined, during encoding, based on a position of the first set of frames in the sequence of frames; and
decoding subsequent frames in the sequence of frames using a second bitrate that is higher than the first bitrate, the second bitrate determined, during encoding, based on content of the digital media contained in the subsequent frames.

19. The system of claim 18, where the set of frames is encoded with a constant bitrate and the subsequent frames are encoded with a constant bitrate or variable bitrate.

20. The system of claim 18, where the first bitrate and the second bitrate are average bitrates.

21. The system of claim 18, where the digital media is audio and the encoding is implemented by one of Advanced Audio coding (AAC), MP3, MP4A or HTTP Live Streaming.

22. The system of claim 18, where the decoding further comprises:
obtaining information related to the first and second bitrates from a table or frame header; and
using the information to determine or derive the first and second bitrates.
